(19) United States
(12) Patent Application Publication
(10) Pub. No.: US 2023/0246779 A1
(43) Pub. Date: Aug. 3, 2023

(54) MULTIPLE PHASE TRACKING REFERENCE SIGNAL CONFIGURATIONS FOR A USER EQUIPMENT

(71) Applicant: QUALCOMM Incorporated, San Diego, CA (US)

(72) Inventors: Fang Yuan, Beijing (CN); Mostafa Khoshnevisan, San Diego, CA (US); Yitao Chen, San Diego, CA (US); Wooseok Nam, San Diego, CA (US); Xiaoxia Zhang, San Diego, CA (US); Tao Luo, San Diego, CA (US)

(21) Appl. No.: 18/001,389

(22) PCT Filed: Jul. 24, 2020
(86) PCT No.: PCT/CN2020/104346

§ 371 Date: Dec. 9, 2022

(51) Int. Cl. H04L 5/00

(52) U.S. Cl. CPC H04L 5/0051; H04L 5/0035; H04L 5/0053

(57) ABSTRACT

A method of wireless communication includes transmitting, by a user equipment (UE) to a base station, a message indicating support of multiple phase tracking reference signal (PTRS) configurations. The method further includes, after transmitting the message, performing a multi-PTRS communication by the UE with the base station. The multi-PTRS communication is performed based on one or more PTRS configurations of the multiple PTRS configurations.

### TECHNICAL FIELD

Aspects of the present disclosure relate generally to wireless communication systems, and more particularly, to wireless communication systems that use phrase tracking reference signals.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In some aspects of the disclosure, a method of wireless communication includes transmitting, by a user equipment (UE) to a base station, a message indicating support of multiple phase tracking reference signal (PTRS) configurations. The method further includes, after transmitting the message, performing, by the UE with the base station, a multi-PTRS communication based on one or more PTRS configurations of the multiple PTRS configurations.

In another aspect of the disclosure, a method of wireless communication includes transmitting, by a UE to a base station, a request to associate a first PTRS configuration of multiple PTRS configurations with a first PTRS of a multi-PTRS communication and to associate a second PTRS configuration of the multiple PTRS configurations with a second PTRS of the multi-PTRS communication. The method further includes, after transmitting the request, performing, by the UE, the multi-PTRS communication with the base station.

In another aspect of the disclosure, a method of wireless communication includes receiving, by a UE, scheduling information from a base station. The UE is configured with multiple PTRS configurations. The method further includes, based on the scheduling information, performing a multi-PTRS communication by the UE. The multi-PTRS communication includes a first PTRS that is communicated based on a particular PTRS configuration of the multiple PTRS configurations and further includes a second PTRS that is communicated based on the particular PTRS configuration of the multiple PTRS configurations.

In another aspect of the disclosure, a method of wireless communication includes receiving, by a base station from a UE, a request to associate a first PTRS configuration of multiple PTRS configurations with a first PTRS of a multi-PTRS communication and to associate a second PTRS configuration of the multiple PTRS configurations with a second PTRS of the multi-PTRS communication. The method further includes, after receiving the request, performing, by the base station, the multi-PTRS communication with the base UE.

In another aspect of the disclosure, a method of wireless communication includes receiving, by a base station from a UE, one or more configuration messages indicating multiple PTRS configurations. The method further includes performing, by the base station, a multi-PTRS communication with the UE based on one or more of the multiple PTRS configurations.

In another aspect of the disclosure, a method of wireless communication includes receiving, by a base station from a UE, scheduling information, where UE is configured with multiple PTRS configurations. The method further includes, based on the scheduling information, performing a multi-PTRS communication by the base station with the UE. The multi-PTRS communication includes a first PTRS that is communicated based on a particular PTRS configuration of the multiple PTRS configurations and further includes a second PTRS that is communicated based on the particular PTRS configuration of the multiple PTRS configurations.

In another aspect of the disclosure, a non-transitory computer-readable medium stores instructions executable by a processor to perform operations. The operations include transmitting, by a UE to a base station, a message indicating support of multiple PTRS configurations. The operations further include, after transmitting the message, performing, by the UE with the base station, a multi-PTRS communication based on one or more PTRS configurations of the multiple PTRS configurations.

In another aspect of the disclosure, an apparatus includes a memory and one or more processors coupled to the memory. The one or more processors are configured to transmit, by a UE to a base station, a message indicating support of multiple PTRS configurations. The one or more processors are further configured to perform, after transmitting the message, a multi-PTRS communication based on one or more PTRS configurations of the multiple PTRS configurations.

In another aspect of the disclosure, an apparatus includes means for transmitting, by a UE to a base station, a message indicating support of multiple PTRS configurations. The apparatus further includes means for performing, by the UE with the base station after transmitting the message, a multi-PTRS communication based on one or more PTRS configurations of the multiple PTRS configurations.

In another aspect of the disclosure, a non-transitory computer-readable medium stores instructions executable by a processor to perform operations. The operations include receiving, from a UE by a base station, a message indicating support of multiple PTRS configurations. The operations further include, after receiving the message, performing, by the base station with the UE, a multi-PTRS communication based on one or more PTRS configurations of the multiple PTRS configurations.

In another aspect of the disclosure, an apparatus includes a memory and one or more processors coupled to the memory. The one or more processors are configured to receive, from a UE by a base station, a message indicating support of multiple PTRS configurations. The one or more processors are further configured to perform, after receiving the message, a multi-PTRS communication based on one or more PTRS configurations of the multiple PTRS configurations.

In another aspect of the disclosure, an apparatus includes means for receiving, from a UE by a base station, a message indicating support of multiple PTRS configurations. The apparatus further includes means for performing, by the base station with the UE after receiving the message, a multi-PTRS communication based on one or more PTRS configurations of the multiple PTRS configurations.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating an example of a wireless communication system according to some aspects of the disclosure.

FIG. 2 is a block diagram illustrating examples of a base station and a UE according to some aspects of the disclosure.

FIG. 3 is a block diagram illustrating another example of a wireless communication system according to some aspects of the disclosure.

FIG. 4 is a diagram illustrating examples of multiplexing schemes according to some aspects of the disclosure.

FIG. 5 is a block diagram illustrating an example of a request that may be transmitted by a UE according to some aspects of the disclosure.

FIG. 6 is a flow chart illustrating an example of a method of wireless communication that may be performed by a UE according to some aspects of the disclosure.

FIG. 7 is a flow chart illustrating an example of a method of wireless communication that may be performed by a base station according to some aspects of the disclosure.

FIG. 8 is a block diagram illustrating an example of a UE according to some aspects of the disclosure.

FIG. 9 is a block diagram illustrating an example of a base station according to some aspects of the disclosure.

### DETAILED DESCRIPTION

Electronic devices use various components and circuits that may be manufactured within certain tolerances. For example, an oscillator may be manufactured to operate within a particular range of accuracy (such as if the oscillator is to produce an output signal having a phase, frequency, or amplitude that is within a particular percentage of a desired phase, frequency, or amplitude). In some cases, newer technologies may be associated with reduced tolerances. For example, to support greater data communication rates, tolerances may need to be reduced, which may increase manufacturing costs (such as by reducing product yield in some cases).

Techniques for selection among and use of multiple phase tracking reference signal (PTRS) configurations are disclosed. In some aspects of the disclosure, a UE supports multiple different PTRS configurations, such as multiple time domain densities, multiple frequency domain densities, or both. In some examples, the UE may indicate one or more of the multiple PTRS configurations to a base station and may perform a multi-PTRS communication with the base station using any of the multiple PTRS configurations. In some examples, performing the multi-PTRS communication includes communicating (e.g., transmitting or receiving) multiple PTRSs having different respective PTRS configurations.

By using different respective PTRS configurations for the multiple PTRSs, the UE may compensate for differences in certain hardware components, such as oscillators. For example, to enable performing the multi-PTRS communication, the UE may include a first oscillator associated with a first PTRS and a second oscillator associated with a second PTRS. The UE may compare performance of the oscillators. In response to the first oscillator performing better than the second oscillator, the UE may decrease one or more of a first time domain density or a first frequency domain density associated with the first PTRS, may increase one or more of a second time domain density or a second frequency domain density associated with the second PTRS, or both. As a result, in some implementations, the UE may support multi-PTRS communications while also supporting a greater tolerance range as compared to devices that use a single PTRS configuration for multiple PTRSs.

To further illustrate, this disclosure relates generally to wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The Third Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. Additionally, an operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects descried with reference to one technology may be understood to be applicable to another technology. Indeed, one or more aspects of the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km\hat{ }2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km\hat{ }2), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated circuits and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

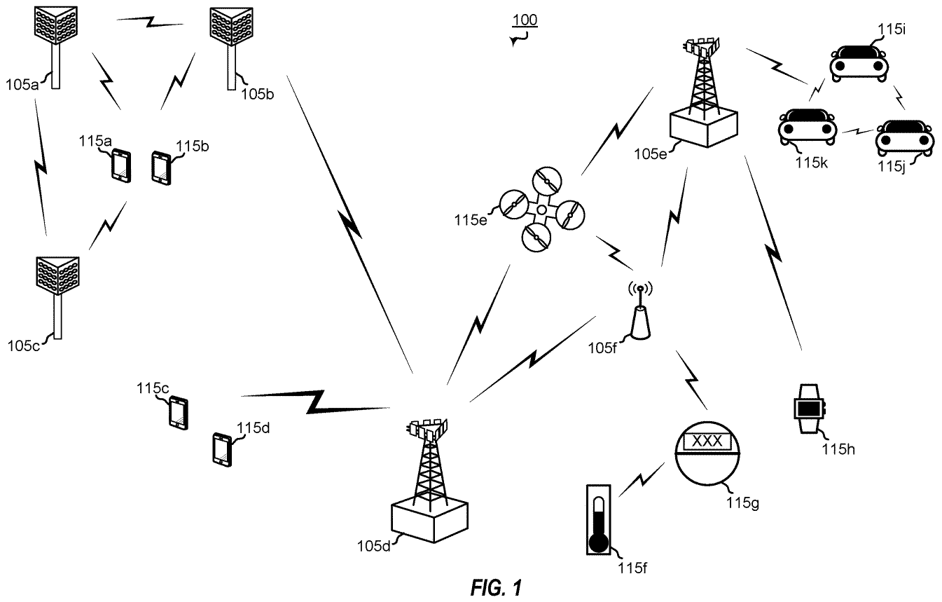

FIG. 1 is a block diagram illustrating details of an example wireless communication system. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component device/module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink and/or uplink, or desired transmission between base stations, and backhaul transmissions between base stations. UEs may operate as base stations or other network nodes in some scenarios. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

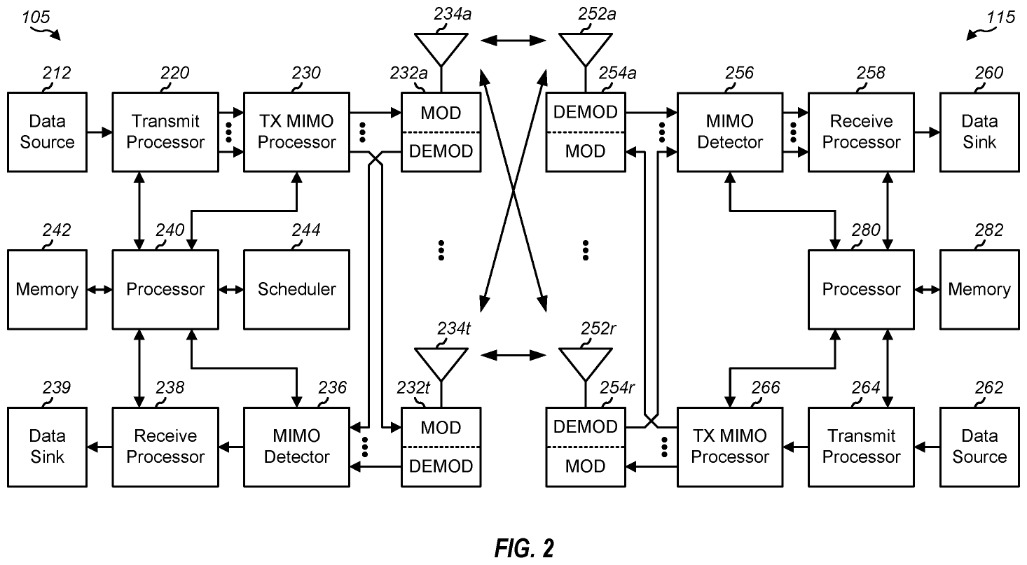

FIG. 2 shows a block diagram conceptually illustrating an example design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, the antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to processor 280.

On the uplink, at UE 115, transmit processor 264 may receive and process data (e.g., for the physical uplink shared channel (PUSCH)) from data source 262 and control information (e.g., for the physical uplink control channel (PUCCH)) from processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to processor 240.

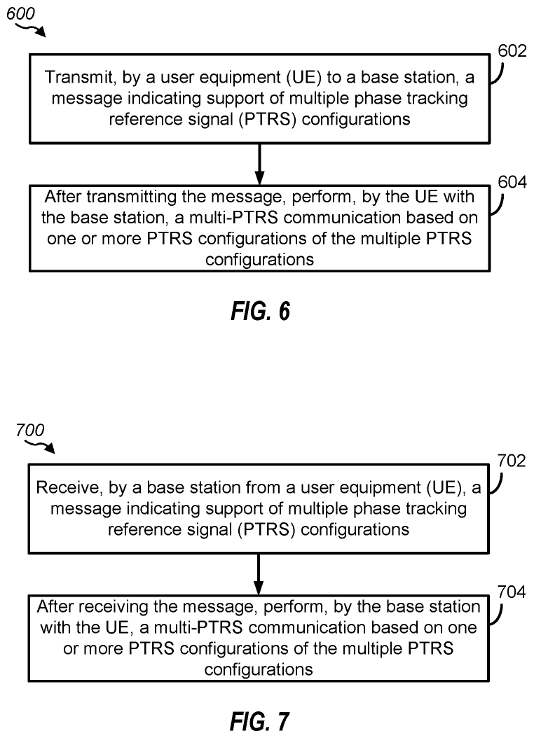

Processors 240 and 280 may direct the operation at base station 105 and UE 115, respectively. Processor 240 and/or other processors and modules at base station 105 and/or processor 280 and/or other processors and modules at UE 115 may perform or direct the execution of various processes for the techniques described herein, such as to perform or direct the execution illustrated in FIG. 6 or FIG. 7, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

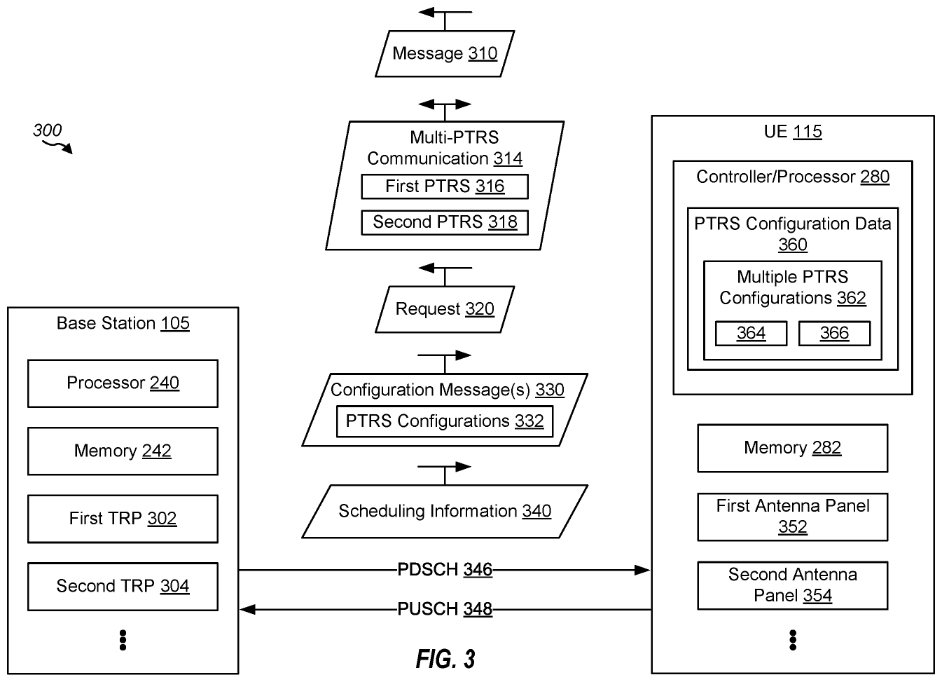

FIG. 3 is a block diagram illustrating another example of a wireless communications system 300 according to some aspects of the disclosure. The wireless communications system 300 includes one or more base stations, such as the base station 105. The wireless communications system 300 further includes one or more UEs, such as the UE 115.

In the example of FIG. 3, the base station 105 includes multiple transmission and reception points (TRPs), such as a first TRP 302 and a second TRP 304. Although the example of FIG. 3 illustrates that the base station 105 may include two TRPs, in other examples, the base station 105 may include a different number of TRPs.

The example of FIG. 3 also illustrates that the UE 115 may include multiple antenna panels, such as a first antenna panel 352 and a second antenna panel 354. Although the example of FIG. 3 illustrates that the UE 115 may include two antenna panels, in other examples, the UE 115 may include a different number of antenna panels.

To further illustrate, the first TRP 302 may communicate with the first antenna panel 352, and the second TRP 304 may communicate with the second antenna panel 354. As an example, the first TRP 302 may transmit a first beam to (or receive the first beam from) the first antenna panel 352. As another example, the second TRP 304 may transmit a second beam to (or receive the second beam from) the second antenna panel 354.

In some examples, the base station 105 and the UE 115 perform a multiple phase tracking reference signal (multi-PTRS) communication 314 to communicate a first PTRS 316 and a second PTRS 318. In one example, during the multi-PTRS communication 314, the base station 105 transmits a PTRS (e.g., the first PTRS 316) from the first TRP 302 to the first antenna panel 352 and transmits a PTRS (e.g., the second PTRS 318) from the second TRP 304 to the second antenna panel 354. Alternatively or in addition, during the multi-PTRS communication 314, the UE 115 may transmit a PTRS (e.g., the first PTRS 316) from the first antenna panel 352 to the first TRP 302 and may transmit a PTRS (e.g., the second PTRS 318) from the second antenna panel 354 to the second TRP 304.

In some aspects of the disclosure, the UE 115 may support multiple phase tracking reference signal (PTRS) configurations 362 for the PTRSs 316, 318. For example, the UE 115 may include circuitry that supports changing one or more parameters of the first PTRS 316 as compared to the second PTRS 318. As an example, the multiple PTRS configurations 362 may include a periodicity with which the PTRSs 316, 318 are transmitted (also referred to herein as a time domain density), which may be every four OFDM symbols, every two OFDM symbols, or every OFDM symbol, as illustrative examples. In this case, the circuitry of the UE 115 may be configured to sample received signals or data to detect the first PTRS 316 based on a first time domain density (e.g., every four OFDM symbols) and to detect the second PTRS 318 based on a second time domain density that is different than the first time domain density (e.g., every two OFDM symbols). As another example, the multiple PTRS configurations 362 may include a number or spacing of frequencies at which the PTRSs 316, 318 are transmitted (also referred to herein as a frequency domain density), which may be every four resource blocks (RBs) or every two RBs, as illustrative examples. In this case, the circuitry of the UE 115 may be configured to tune to different frequencies to detect the first PTRS 316 based on a first frequency domain density (e.g., every four RBs) and to detect the second PTRS 318 based on a second frequency domain density that is different than the first frequency domain density (e.g., every two RBs).

In some examples, the base station 105 and the UE 115 operate based on a wireless communication protocol, and one or more parameters of the multiple PTRS configurations 362 (such as time domain densities and frequency domain densities) are selected from values specified by the wireless communication protocol. To illustrate, the wireless communication protocol may specify different values of a time domain density (e.g., every four OFDM symbols, every two OFDM symbols, or every OFDM symbol) and may further specify different values of a frequency domain density (e.g., every four RBs or every two RBs). In some aspects of the disclosure, the UE 115 supports different time domain densities for the PTRSs 316, 318, different frequency domain densities for the PTRSs 316, 318, or both.

In a first technique, the UE 115 may transmit, to the base station 105, a message 310 indicating support of the multiple PTRS configurations 362 by the UE 115. In one example, the message 310 includes an indication (e.g., a bit or a flag) indicating whether the UE 115 supports multiple PTRS configurations for the PTRSs 316, 318. In some other examples, the message 310 indicates the PTRS configuration data 360 (or at least a portion of the PTRS configuration data 360), such as one or more time domain densities supported by the UE 115, one or more frequency domain densities supported by the UE 115, one or more other PTRS configurations, or a combination thereof.

After transmission of the message 310, the UE 115 and the base station 105 may perform the multi-PTRS communication 314 based on one or more PTRS configurations of the multiple PTRS configurations 362. In some examples, one or more of the base station 105 and the UE 115 may select, from among the PTRS configurations 362, the one or more PTRS configurations for the multi-PTRS communication 314, as described further below.

In some examples, performing the multi-PTRS communication 314 includes transmitting, by the base station 105, the first PTRS 316 based on a first PTRS configuration 364 of the multiple PTRS configurations 362 via a physical downlink shared channel (PDSCH) 346 and transmitting the second PTRS 318 based on a second PTRS configuration 366 of the multiple PTRS configurations 362 via the PDSCH 346. The base station 105 may transmit the first PTRS 316 and the second PTRS 318 using the first TRP 302 and the second TRP 304, respectively, and the UE 115 may receive the first PTRS 316 and the second PTRS 318 using the first antenna panel 352 and the second antenna panel 354, respectively. In some examples, the first PTRS configuration 364 includes a first time domain density, a first frequency domain density, or both, and the second PTRS configuration 366 includes a second time domain density different then the first time domain density, a second frequency domain density different than the first frequency domain density, or both.

In some other examples, performing the multi-PTRS communication 314 includes transmitting, by the UE 115, the first PTRS 316 based on the first PTRS configuration 364 via a physical uplink shared channel (PUSCH) 348 and transmitting the second PTRS 318 based on the second PTRS configuration 366 via the PUSCH 348. The UE 115 may transmit the first PTRS 316 and the second PTRS 318 using the first antenna panel 352 and the second antenna panel 354, respectively, and the UE 115 may receive the first PTRS 316 and the second PTRS 318 using the first TRP 302 and the second TRP 304, respectively.

Although the example of FIG. 3 depicts a single message 310, in some examples, the UE 115 transmits multiple messages 310. In some implementations, the UE 115 reports the supporting of the multiple PTRS configurations 362 per frequency band. For example, the UE 115 may communicate using a plurality of frequency bands and may transmit the message 310 for each frequency band of the plurality of frequency bands. Alternatively or in addition, the UE 115 may report the supporting of the multiple PTRS configurations 362 per serving cell. For example, the UE 115 may communicate with a plurality of serving cells (e.g., where the base station 105 corresponds to one of the serving cells) and may transmit the message 310 for each serving cell of a plurality of the serving cells.

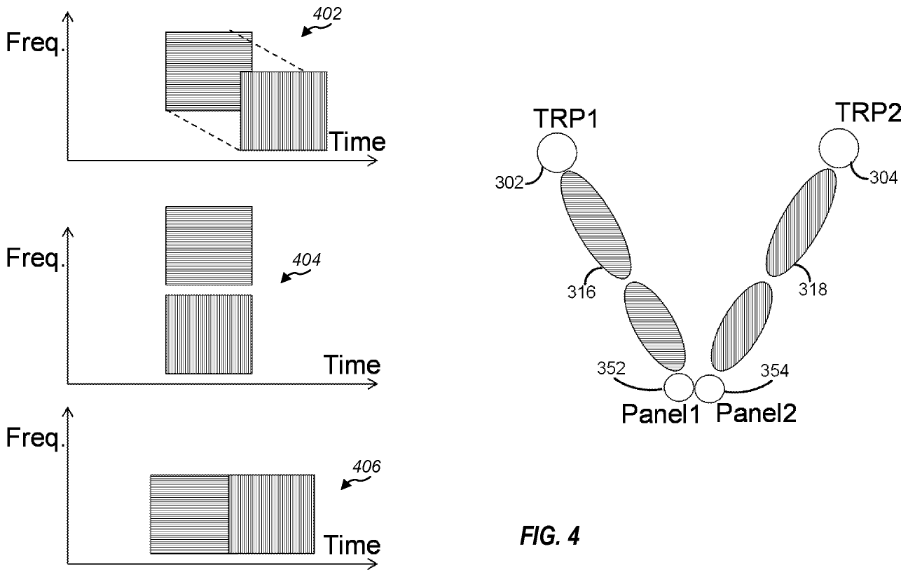

In some implementations, the base station 105 and the UE 115 perform the multi-PTRS communication 314 based on the one or more PTRS configurations. In one example, the first PTRS 316 is multiplexed with the second PTRS 318 based on a spatial division multiplexing (SDM) scheme, based on a frequency division multiplexing (FDM) scheme, based on a time division multiplexing (TDM) scheme, or based on another multiplexing scheme. To illustrate, FIG. 4, depicts examples of a SDM scheme 402, a FDM scheme 404, and a TDM scheme 406 that may be used to communicate the PTRSs 316, 318 (e.g., via the PDSCH 346 or via the PUSCH 348).

Referring again to FIG. 3, in a second technique alternatively or in addition to the first technique, the UE 115 may transmit, to the base station 105, a request 320 to associate a PTRS with a particular PTRS configuration. For example, the request 320 may indicate a request (e.g., a recommendation) to associate the first PTRS configuration 364 with the first PTRS 316 and to associate the second PTRS configuration 366 with the second PTRS 318.

In some implementations, the request 320 is included in an uplink medium access control (MAC) control element (MAC-CE). In some other implementations, the request 320 is included in uplink control information (UCI). The request 320 may indicate a TRP to be associated with a PTRS, an antenna panel to be associated with a PTRS, or both. For example, the request 320 may indicate one or more of the first TRP 302 associated with the first PTRS 316, the second TRP 304 associated with the second PTRS 318, a first panel identifier (ID) associated with the first PTRS 316 (e.g., a panel ID of the first antenna panel 352), or a second panel ID associated with the second PTRS 318 (e.g., a panel ID of the second antenna panel 354).

The base station 105 and the UE 115 may perform the multi-PTRS communication 314 based on the request 320. For example, the UE 115 may receive the first PTRS 316 from the first TRP 302 using the first antenna panel 352 and may receive the second PTRS 318 from the second TRP 304 using the second antenna panel 354. In another example, the base station 105 may receive the first PTRS 316 from the first antenna panel 352 using the first TRP 302 and may receive the second PTRS 318 from the second antenna panel 354 using the second TRP 304.

In some implementations in accordance with the second technique, the request 320 is based on or indicates one or more of a minimum time domain density associated with the UE 115 or a minimum frequency domain density associated with the UE 115. For example, the PTRS configuration data 360 may indicate, based on particular hardware or circuitry of the UE 115, one or more of the minimum time domain density or the minimum frequency domain density supported by the UE 115.

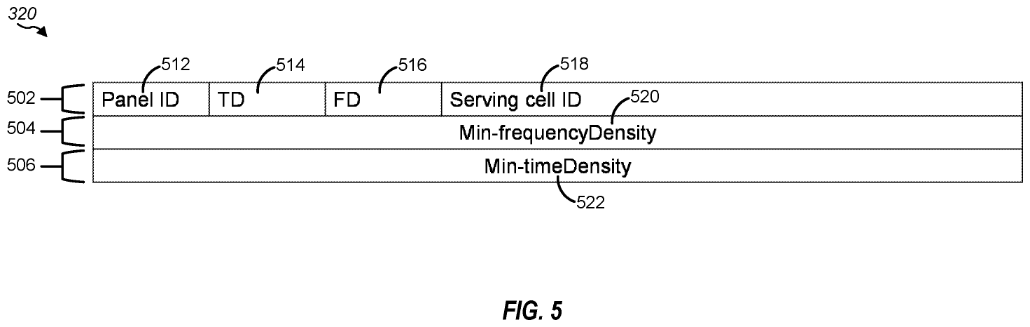

To further illustrate, FIG. 5 depicts an illustrative example of the request 320. In some implementations, the example of the request 320 illustrated in FIG. 5 corresponds to an uplink MAC-CE. In FIG. 5, the request 320 may include an ID 512 of a panel or a TRP (or both), a time domain density indicator 514, a frequency domain density indicator 516, a serving cell ID 518, a minimum frequency domain density 520, and a minimum time domain density 522. In an illustrative example, the request 320 includes a first byte 502 indicating the ID 512, the time domain density indicator 514, the frequency domain density indicator 516, and the serving cell ID 518. The request 320 may also include a second byte 504 indicating the minimum frequency domain density 520 if the frequency domain density indicator 516 is set to a particular value (e.g., 1) and may further include a third byte 506 indicating the minimum time domain density 522 if the time domain density indicator 514 is set to a particular value (e.g., 1).

Referring again to FIG. 3, in a third technique of the disclosure alternatively or in addition to one or more of the first and second techniques, the UE 115 may receive one or more configuration messages 330 from the base station 105 indicating one or more PTRS configurations 332, and the UE 115 and the base station 105 may perform the multi-PTRS communication 314 based on the one or more PTRS configurations 332. To illustrate, the one or more configuration messages 330 may include one or more of a downlink configuration message, an uplink configuration message, a DMRS configuration message, or a PTRS configuration message. In some examples, the one or more configuration messages 330 are associated with the PDSCH 346, such as if the one or more configuration messages 330 include one or more of a PDSCH configuration message, a DMRS downlink configuration message, or a PTRS downlink configuration message. In some other examples, the one or more configuration messages 330 are associated with the PUSCH 348, such as if the one or more configuration messages 330 include one or more of a PUSCH configuration message, a DMRS uplink configuration message, or a PTRS uplink configuration message.

In some examples, at least one of the one or more configuration messages 330 indicates a selection, from among the multiple PTRS configurations 362, of one or more PTRS configurations used for the multi-PTRS communication 314. For example, the selection may accept a recommendation of one or more of the multiple PTRS configurations 362 indicated by the request 320, may deny a recommendation of one or more of the multiple PTRS configurations 362 indicated by the request 320, or both. The selection may correspond to the one or more PTRS configurations 332. To illustrate, the one or more configuration messages 330 may include a PTRS configuration message (e.g., a PTRS downlink configuration message or a PTRS uplink configuration message) sent by the base station 105 to the UE 115 in response to the message 310 and indicating the one or more PTRS configurations 332. As an example, the PTRS configuration message may indicate a first time domain density of the first PTRS 316, a second time domain density of the second PTRS 318, or both. Alternatively or in addition, the PTRS configuration message may indicate a first frequency domain density of the first PTRS 316, a second frequency domain density of the second PTRS 318, or both.

In some implementations, the one or more configuration messages 330 may indicate that each PTRS configuration of the one or more PTRS configurations 332 is associated with a respective TRP or panel ID. For example, the one or more configuration messages 330 may include an indication of an assignment of the one or more PTRS configurations 332 to one or more TRPs, to one or more antenna panels, or both. As an example, the indication may specify that a first PTRS configuration of the one or more PTRS configurations 332 (e.g., the first PTRS configuration 364) is assigned to the first TRP 302, to the first antenna panel 352, or both, and the indication may further specify that a second PTRS configuration of the one or more PTRS configurations 332 (e.g., the second PTRS configuration 366) is assigned to the second TRP 304, to the second antenna panel 354, or both.

The indication may correspond to an explicit indication or to an implicit indication. To illustrate, in one example, the one or more configuration messages 330 include a PTRS configuration message explicitly identifying each TRP or panel ID. In some other examples, the UE 115 determines the TRP or panel ID using an implicit technique. For example, the UE 115 may determine the TRP or panel ID based on one or more of a control resource set (CORESET) pool ID indicated by the one or more configuration messages 330, a sounding reference signal (SRS) resource ID indicated by the one or more configuration messages 330, an SRS resource set ID indicated by the one or more configuration messages 330, an uplink transmission configuration indicator (TCI) ID indicated by the one or more configuration messages 330, a code division multiplexing (CDM) group ID indicated by the one or more configuration messages 330, or another indicator associated with the TRP or panel ID indicated by the one or more configuration messages 330.

To further illustrate, in one example, the UE 115 receives scheduling information 340 from the base station 105 indicating a multi-panel PUSCH transmission of the multi-PTRS communication 314. The scheduling information 340 may be included in the one or more configuration messages 330 and may indicate the one or more PTRS configurations 332. Based on the scheduling information 340, the UE 115 may determine panel IDs and may perform the multi-panel PUSCH transmission based on the panel IDs (e.g., by transmitting the PTRSs 316, 318 using the antenna panels 352, 354).

In some examples, the scheduling information 340 includes a downlink control information (DCI) message that indicates multiple transmission configuration indicator (TCI) IDs, and the UE 115 applies the one or more PTRS configurations 332 to the multi-panel PUSCH transmission based on the DCI message indicating the multiple TCI IDs. In some other examples, the scheduling information 340 includes multiple DCI messages (e.g., a first DCI message and a second DCI message), and the UE 115 applies the multiple PTRS configurations 332 to the multi-panel PUSCH transmission based on the first DCI message indicating a first CORESET pool index value and further based on the second DCI message indicating a second CORESET pool index value.

In a fourth technique of the disclosure alternatively or in addition to one or more of the first through third techniques, the UE 115 may receive scheduling information, such as the scheduling information 340, from the base station 105 and may determine, from among the multiple PTRS configurations 362, a particular PTRS configurations for the multi-PTRS communication 314. For example, if the scheduling information 340 indicates a TRP or antenna panel that is not associated with any PTRS configuration, then the UE 115 may “choose” the particular PTRS configuration based on one or more criteria. Thus, in some examples of the fourth technique, the UE 115 may select a particular PTRS configuration from among the multiple PTRS configurations 362, such as based on determining that the scheduling information 340 indicates a panel or TRP that is not associated with any PTRS configuration. In some examples, the particular PTRS configuration is applied to both the PTRSs 316, 318 during the multi-PTRS communication 314.

To further illustrate, in some examples of the fourth technique, performing the multi-PTRS communication 314 includes transmitting the first PTRS 316 via the PUSCH 348 based on the particular PTRS configuration using the first antenna panel 352 of the UE 115 and further includes transmitting the second PTRS 318 via the PUSCH 348 based on the particular PTRS configuration using the second antenna panel 354. In some examples, the particular PTRS configuration is selected from among the multiple PTRS configurations 362 based on an identification that the particular PTRS configuration is associated with a greatest time domain density among the antenna panels 352, 354, a greatest frequency domain density among the antenna panels 352, 354, a least time domain density among the antenna panels 352, 354, or a least frequency domain density among the antenna panels 352, 354 (where each antenna panel is associated with a respective time domain density, frequency domain density, or both).

In another illustrative example, performing the multi-PTRS communication 314 includes receiving the first PTRS 316 via the PDSCH 346 from the first TRP 302 of the base station 105 based on the particular PTRS configuration and further includes receiving the second PTRS 318 via the PDSCH 346 from the second TRP 304 of the base station 105 based on the particular PTRS configuration. In some examples, the particular PTRS configuration is selected from among the multiple PTRS configurations 362 based on an identification that the particular PTRS configuration is associated with a greatest time domain density among the TRPs 302, 304, a greatest frequency domain density among the TRPs 302, 304, a least time domain density among the TRPs 302, 304, or a least frequency domain density among the TRPs 302, 304 (where each TRP is associated with a respective time domain density, frequency domain density, or both).

To further illustrate certain aspects of the disclosure, a time domain density may be selected based on a modulation and coding scheme (MCS) (or a range of MCSs) used to communicate data between the base station 105 and the UE 115. For example, a first set of MCSs, a second set of MCSs, a third set of MCSs, and a fourth set of MCSs may be associated with no PTRS, a time domain density of four, a time domain density of two, or a time domain density of one, as illustrative examples. Alternatively or in addition, a frequency domain density may be selected based on a scheduled bandwidth used to communicate data between the base station 105 and the UE 115. For example, a first scheduled bandwidth, a scheduled bandwidth, and a third scheduled bandwidth may be associated with no PTRS, a frequency domain density of two, and a frequency domain density of four, as illustrative examples.

In some examples, the one or more configuration messages 330 include an uplink or downlink configuration (PxSCH-Config) message, an uplink or downlink DMRS configuration (DMRS-XlinkConfig) message, an uplink or downlink PTRS configuration (PTRS-XlinkConfig) message, one or more other messages, or a combination thereof. Examples 1, 2, and 3 illustrate certain examples of the PxSCH-Config message, the DMRS-XlinkConfig message, and the PTRS-XlinkConfig message, respectively:

### Example 1

```
PxSCH-Config ::= SEQUENCE {
  dmrs-UplinkForPUSCH-MappingTypeA SetupRelease {
  DMRS-XlinkConfig }
  dmrs-UplinkForPUSCH-MappingTypeB SetupRelease {
  DMRS-XlinkConfig }
  ...
}
```

### Example 2

```
DMRS-XlinkConfig ::= SEQUENCE {
  dmrs-Type ENUMERATED {type2}
  dmrs-AdditionalPosition ENUMERATED {pos0, pos1, pos3}
  phase TrackingRS SetupRelease { PTRS-XlinkConfig }
  ...
}
```

### Example 3

```
PTRS-XlinkConfig ::= SEQUENCE {
  frequencyDensity SEQUENCE (SIZE (2)) OF INTEGER (1..276)
  timeDensity SEQUENCE (SIZE (3)) OF INTEGER (0..29)
  resourceElementOffset ENUMERATED {offset01, offset10, offset11 }
  ...
}
```

Example 4 illustrates another example of the PTRS-XlinkConfig message. In Example 4, the PTRS-XlinkConfig message explicitly indicates panel IDs of the UE:

### Example 4

```
PTRS-XlinkConfig ::= SEQUENCE {
  panelID, PanelID
  frequencyDensity SEQUENCE (SIZE (2)) OF INTEGER (1..276)
    timeDensity SEQUENCE (SIZE (3)) OF INTEGER (0..29)
    maxNrofPorts ENUMERATED {n1, n2},
    resourceElementOffset ENUMERATED {offset01, offset10,
    offset11 }
    ptrs-Power ENUMERATED {p00, p01, p10, p11}
  ...
}
```

One or more aspects described with reference to Examples 1-4 and FIGS. 3-5 may improve performance of a wireless communication system, such as the wireless communication system 300. For example, by using different respective PTRS configurations for the multi-PTRS communication 314, the UE 115 may compensate for differences in certain hardware components, such as oscillators. For example, to enable performing the multi-PTRS communication 314, the UE 115 may include a first oscillator associated with the first PTRS 316 and a second oscillator associated with the second PTRS 318. The UE 115 may compare performance of the oscillators. In response to the first oscillator performing better than the second oscillator, the UE may decrease one or more of a first time domain density or a first frequency domain density associated with the first PTRS 316, may increase one or more of a second time domain density or a second frequency domain density associated with the second PTRS 318, or both. As a result, in some implementations, the UE 115 may support multi-PTRS communications while also supporting a greater tolerance range as compared to devices that use a single PTRS configuration for multiple PTRSs.

FIG. 6 is a flow chart illustrating an example of a method 600 of wireless communication that may be performed by a UE according to some aspects of the disclosure. In some examples, operations of the method 600 are performed by the UE 115.

The method 600 includes transmitting, by a UE to a base station, a message indicating support of multiple PTRS configurations, at 602. For example, the UE 115 may transmit the message 310 to the base station 105 to indicate that the UE 115 supports the multiple PTRS configurations 362.

The method 600 further includes, after transmitting the message, performing, by the UE with the base station, a multi-PTRS communication based on one or more PTRS configurations of the multiple PTRS configurations, at 604. For example, after transmitting the message 310, the UE 115 may perform the multi-PTRS communication 314 with the base station 105 based on one or more PTRS configurations of the multiple PTRS configurations 362.

FIG. 7 is a flow chart illustrating an example of a method 700 of wireless communication that may be performed by a base station according to some aspects of the disclosure. In some examples, operations of the method 700 are performed by the base station 105.

The method 700 includes receiving, by a base station from a UE, a message indicating support of multiple PTRS configurations, at 702. For example, the base station 105 may receive the message 310 from the UE 115 indicating that the UE 115 supports the multiple PTRS configurations 362.

The method 700 further includes, after receiving the message, performing, by the base station with the UE, a multi-PTRS communication based on one or more PTRS configurations of the multiple PTRS configurations, at 704. For example, after receiving the message 310, the base station 105 may perform the multi-PTRS communication 314 with the UE 115 based on one or more PTRS configurations of the multiple PTRS configurations 362.

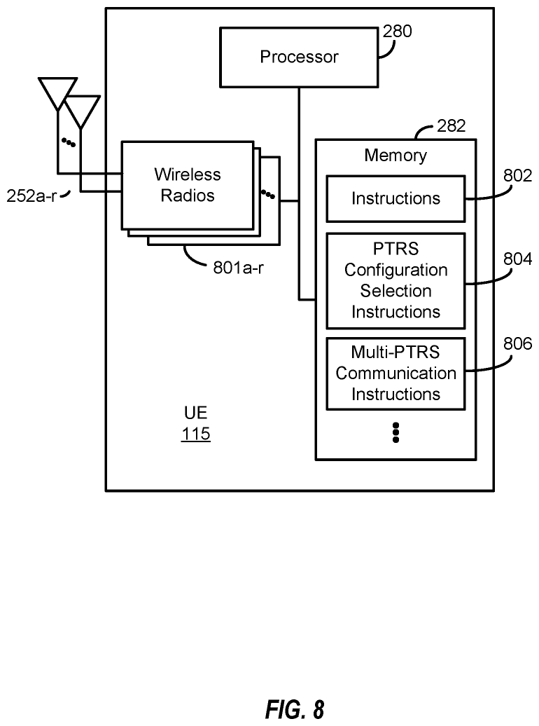

FIG. 8 is a block diagram illustrating an example of a UE 115 according to some aspects of the disclosure. The UE 115 may include the processor 280 and the memory 282. The processor 280 may execute instructions 802 stored in the memory 282 to initiate, perform, or control one or more operations described herein. The processor 280 may execute the instructions 802 to transmit and receive signals via wireless radios 801a-r and the antennas 252a-r. The wireless radios 801a-r may include hardware or other components corresponding to one or more features described with reference to FIG. 2, such as the modulator/demodulators 254a-r, the MIMO detector 256, the receive processor 258, the transmit processor 264, the TX MIMO processor 266, one or more other components, or a combination thereof. In some examples, the processor 280 executes PTRS configuration selection instructions 804 to select among the multiple PTRS configurations 362 of FIG. 3. The processor 280 may execute multi-PTRS communication instructions 806 to perform a multi-PTRS communication (such as the multi-PTRS communication 314) based on one or more of the multiple PTRS configurations 362.

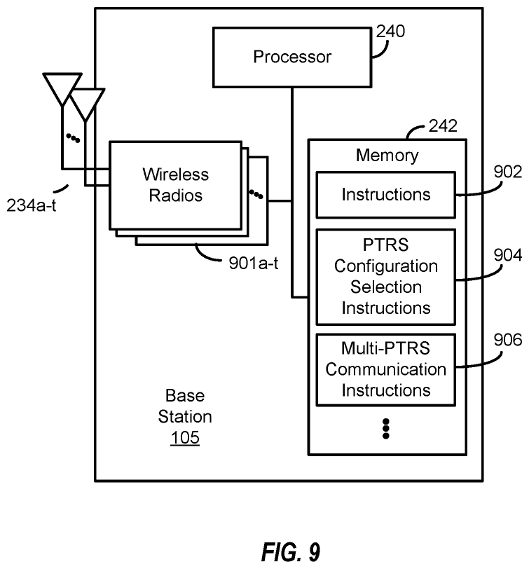

FIG. 9 is a block diagram illustrating an example of a base station 105 according to some aspects of the disclosure. The base station 105 may include the processor 240 and the memory 242. The processor 240 may execute instructions 902 stored in the memory 242 to initiate, perform, or control one or more operations described herein. The processor 240 may execute the instructions 902 to transmit and receive signals via wireless radios 901a-t and the antennas 234a-t. The wireless radios 901a-t may include hardware or other components corresponding to one or more features described with reference to FIG. 2, such as the modulator/demodulators 232a-t, the MIMO detector 236, the receive processor 238, the receive processor 238, the TX MIMO processor 230, one or more other components, or a combination thereof. In some examples, the processor 240 executes PTRS configuration selection instructions 904 to select among the multiple PTRS configurations 362 of FIG. 3. The processor 240 may execute multi-PTRS communication instructions 906 to perform a multi-PTRS communication (such as the multi-PTRS communication 314) based on one or more of the multiple PTRS configurations 362.

In a first aspect, a method of wireless communication includes transmitting, by a UE to a base station, a message indicating support of multiple PTRS configurations. The method further includes, after transmitting the message, performing, by the UE with the base station, a multi-PTRS communication based on one or more PTRS configurations of the multiple PTRS configurations.

In a second aspect alternatively or in addition to the first aspect, the multiple PTRS configurations include a first time domain density associated with a first PTRS of the multi-PTRS communication and further include second time domain density associated with a second PTRS of the multi-PTRS communication, the second time domain density different than the first time domain density.

In a third aspect alternatively or in addition to one or more of the first through second aspects, the multiple PTRS configurations include a first frequency domain density associated with a first PTRS of the multi-PTRS communication and further include second frequency domain density associated with a second PTRS of the multi-PTRS communication, the second frequency domain density different than the first frequency domain density.

In a fourth aspect alternatively or in addition to one or more of the first through third aspects, performing the multi-PTRS communication includes receiving, from a plurality of TRPs of the base station, multiple PTRSs via a PDSCH.

In a fifth aspect alternatively or in addition to one or more of the first through fourth aspects, the multiple PTRSs include a first PTRS transmitted to a first antenna panel of the UE based on a first PTRS configuration of the multiple PTRS configurations and further include a second PTRS transmitted to a second antenna panel of the UE based on a second PTRS configuration of the multiple PTRS configurations.

In a sixth aspect alternatively or in addition to one or more of the first through fifth aspects, performing the multi-PTRS communication includes transmitting, using a plurality of antenna panels of the UE, multiple PTRSs to the base station via a PUSCH.

In a seventh aspect alternatively or in addition to one or more of the first through sixth aspects, the multiple PTRSs include a first PTRS transmitted by a first antenna panel of the UE based on a first PTRS configuration of the multiple PTRS configurations and further include a second PTRS transmitted by a second antenna panel of the UE based on a second PTRS configuration of the multiple PTRS configurations.

In an eighth aspect alternatively or in addition to one or more of the first through seventh aspects, the UE transmits the message for each frequency band of a plurality of frequency bands.

In a ninth aspect alternatively or in addition to one or more of the first through eighth aspects, the UE transmits the message for each serving cell of a plurality of serving cells.

In a tenth aspect alternatively or in addition to one or more of the first through ninth aspects, the method further includes receiving, by the UE from the base station, one or more configuration messages indicating a selection of the one or more PTRS configurations.

In an eleventh aspect alternatively or in addition to one or more of the first through tenth aspects, the one or more configuration messages are associated with a PUSCH.

In a twelfth aspect alternatively or in addition to one or more of the first through eleventh aspects, the one or more configuration messages are associated with a PDSCH.

In a thirteenth aspect alternatively or in addition to one or more of the first through twelfth aspects, a first PTRS of the multi-PTRS communication is multiplexed with a second PTRS of the multi-PTRS communication based on a SDM scheme.

In a fourteenth aspect alternatively or in addition to one or more of the first through thirteenth aspects, a first PTRS of the multi-PTRS communication is multiplexed with a second PTRS of the multi-PTRS communication based on a FDM scheme.

In a fifteenth aspect alternatively or in addition to one or more of the first through fourteenth aspects, a first PTRS of the multi-PTRS communication is multiplexed with a second PTRS of the multi-PTRS communication based on a TDM scheme.

In a sixteenth aspect alternatively or in addition to one or more of the first through fifteenth aspects, a method of wireless communication includes transmitting, by a UE to a base station, a request to associate a first PTRS configuration of multiple PTRS configurations with a first PTRS of a multi-PTRS communication and to associate a second PTRS configuration of the multiple PTRS configurations with a second PTRS of the multi-PTRS communication. The method further includes, after transmitting the request, performing, by the UE, the multi-PTRS communication with the base station.

In a seventeenth aspect alternatively or in addition to one or more of the first through sixteenth aspects, the request is included in an uplink MAC-CE that indicates one or more of a first TRP associated with the first PTRS, a second TRP associated with the second PTRS, a first panel ID associated with the first PTRS, or a second panel ID associated with the second PTRS.

In an eighteenth aspect alternatively or in addition to one or more of the first through seventeenth aspects, the request is included in uplink control information (UCI) that indicates one or more of a first TRP associated with the first PTRS, a second TRP associated with the second PTRS, a first panel ID associated with the first PTRS, or a second panel ID associated with the second PTRS.

In a nineteenth aspect alternatively or in addition to one or more of the first through eighteenth aspects, performing the multi-PTRS communication includes: receiving, by the UE, the first PTRS from a first TRP of the base station using a first antenna panel of the UE; and receiving, by the UE, the second PTRS from a second TRP of the base station using a second antenna panel of the UE.

In a twentieth aspect alternatively or in addition to one or more of the first through nineteenth aspects, performing the multi-PTRS communication includes: transmitting, by the UE, the first PTRS to a first TRP of the base station using a first antenna panel of the UE; and transmitting, by the UE, the second PTRS to a second TRP of the base station using a second antenna panel of the UE.

In a twenty-first aspect alternatively or in addition to one or more of the first through twentieth aspects, the request includes one or more of a minimum time domain density indicator associated with the UE or a minimum frequency domain density indicator associated with the UE.

In a twenty-second aspect alternatively or in addition to one or more of the first through twenty-first aspects, the request includes a first byte indicating an ID of a panel or a TRP, a time domain density indicator, a frequency domain density indicator, and a serving cell ID.

In a twenty-third aspect alternatively or in addition to one or more of the first through twenty-second aspects, the request further includes a second byte indicating a minimum frequency domain density indicated by the UE.

In a twenty-fourth aspect alternatively or in addition to one or more of the first through twenty-third aspects, the request further includes a third byte indicating a minimum time domain density indicated by the UE.

In a twenty-fifth aspect alternatively or in addition to one or more of the first through twenty-fourth aspects, a method of wireless communication includes receiving, by a UE from a base station, one or more configuration messages indicating multiple PTRS configurations. The method further includes performing, by the UE, a multi-PTRS communication with the base station based on one or more of the multiple PTRS configurations.

In a twenty-sixth aspect alternatively or in addition to one or more of the first through twenty-fifth aspects, each PTRS configuration of the multiple PTRS configurations is associated with a respective TRP or panel ID.

In a twenty-seventh aspect alternatively or in addition to one or more of the first through twenty-sixth aspects, the one or more configuration messages include a PTRS configuration message explicitly identifying each TRP or panel ID.

In a twenty-eighth aspect alternatively or in addition to one or more of the first through twenty-seventh aspects, the method further includes determining the TRP or panel ID using an implicit technique.

In a twenty-ninth aspect alternatively or in addition to one or more of the first through twenty-eighth aspects, the TRP or panel ID is determined based on one or more of a CORESET pool ID, a SRS resource ID, an SRS resource set ID, an uplink TCI ID, a CDM group ID, or another indicator associated with the TRP or panel ID.

In a thirtieth aspect alternatively or in addition to one or more of the first through twenty-ninth aspects, the method further includes receiving, by the UE, scheduling information from the base station indicating a multi-panel PUSCH transmission of the multi-PTRS communication; determining panel IDs based on the scheduling information; and performing the multi-panel PUSCH transmission based on the panel IDs.

In a thirty-first aspect alternatively or in addition to one or more of the first through thirtieth aspects, the scheduling information includes a downlink control information (DCI) message that indicates multiple transmission configuration indicator (TCI) IDs, and the UE applies the multiple PTRS configurations to the multi-panel PUSCH transmission based on the DCI message indicating the multiple TCI IDs.

In a thirty-second aspect alternatively or in addition to one or more of the first through thirty-first aspects, the scheduling information includes a first downlink control information (DCI) message and a second DCI message, and the UE applies the multiple PTRS configurations to the multi-panel PUSCH transmission based on the first DCI message indicating a first CORESET pool index value and further based on the second DCI message indicating a second CORESET pool index value.

In a thirty-third aspect alternatively or in addition to one or more of the first through thirty-second aspects, a method of wireless communication includes receiving, by a UE, scheduling information from a base station. The UE is configured with multiple PTRS configurations. The method further includes, based on the scheduling information, performing a multi-PTRS communication by the UE. The multi-PTRS communication includes a first PTRS that is communicated based on a particular PTRS configuration of the multiple PTRS configurations and further includes a second PTRS that is communicated based on the particular PTRS configuration of the multiple PTRS configurations.

In a thirty-fourth aspect alternatively or in addition to one or more of the first through thirty-third aspects, performing the multi-PTRS communication includes transmitting the first PTRS via a PUSCH based on the particular PTRS configuration using a first antenna panel of multiple antenna panels of the UE and further includes transmitting the second PTRS via the PUSCH based on the particular PTRS configuration using a second antenna panel of the multiple antenna panels.

In a thirty-fifth aspect alternatively or in addition to one or more of the first through thirty-fourth aspects, the method further includes selecting the particular PTRS configuration from among the multiple PTRS configurations based on an identification that the particular PTRS configuration is associated with a greatest time domain density among the multiple antenna panels.

In a thirty-sixth aspect alternatively or in addition to one or more of the first through thirty-fifth aspects, the method further includes selecting the particular PTRS configuration from among the multiple PTRS configurations based on an identification that the particular PTRS configuration is associated with a greatest frequency domain density among the multiple antenna panels.

In a thirty-seventh aspect alternatively or in addition to one or more of the first through thirty-sixth aspects, the method further includes selecting the particular PTRS configuration from among the multiple PTRS configurations based on an identification that the particular PTRS configuration is associated with a least time domain density among the multiple antenna panels.

In a thirty-eighth aspect alternatively or in addition to one or more of the first through thirty-seventh aspects, the method further includes selecting the particular PTRS configuration from among the multiple PTRS configurations based on an identification that the particular PTRS configuration is associated with a least frequency domain density among the multiple antenna panels.

In a thirty-ninth aspect alternatively or in addition to one or more of the first through thirty-eighth aspects, performing the multi-PTRS communication includes receiving the first PTRS via a PDSCH from a first TRP of multiple TRPs of the base station based on the particular PTRS configuration and further includes receiving the second PTRS via the PDSCH from a second TRP of the multiple TRPs based on the particular PTRS configuration.

In a fortieth aspect alternatively or in addition to one or more of the first through thirty-ninth aspects, the method further includes selecting the particular PTRS configuration from among the multiple PTRS configurations based on an identification that the particular PTRS configuration is associated with a greatest time domain density among the multiple TRPs.

In a forty-first aspect alternatively or in addition to one or more of the first through fortieth aspects, the method further includes selecting the particular PTRS configuration from among the multiple PTRS configurations based on an identification that the particular PTRS configuration is associated with a greatest frequency domain density among the multiple TRPs.

In a forty-second aspect alternatively or in addition to one or more of the first through forty-first aspects, the method further includes selecting the particular PTRS configuration from among the multiple PTRS configurations based on an identification that the particular PTRS configuration is associated with a least time domain density among the multiple TRPs.

In a forty-third aspect alternatively or in addition to one or more of the first through forty-second aspects, the method further includes selecting the particular PTRS configuration from among the multiple PTRS configurations based on an identification that the particular PTRS configuration is associated with a least frequency domain density among the multiple TRPs.

In a forty-fourth aspect alternatively or in addition to one or more of the first through forty-third aspects, the UE selects the particular PTRS configuration based on determining that the scheduling information indicates a panel or TRP that is not associated with any PTRS configuration.

In a forty-fifth aspect alternatively or in addition to one or more of the first through forty-fourth aspects, a method of wireless communication includes receiving, by a base station from a UE, a message indicating support of multiple PTRS configurations. The method further includes, after receiving the message, performing, by the base station with the UE, a multi-PTRS communication based on one or more PTRS configurations of the multiple PTRS configurations.

In a forty-sixth aspect alternatively or in addition to one or more of the first through forty-fifth aspects, the multiple PTRS configurations include a first time domain density associated with a first PTRS of the multi-PTRS communication and further include second time domain density associated with a second PTRS of the multi-PTRS communication, the second time domain density different than the first time domain density.

In a forty-seventh aspect alternatively or in addition to one or more of the first through forty-sixth aspects, the multiple PTRS configurations include a first frequency domain density associated with a first PTRS of the multi-PTRS communication and further include second frequency domain density associated with a second PTRS of the multi-PTRS communication, the second frequency domain density different than the first frequency domain density.

In a forty-eighth aspect alternatively or in addition to one or more of the first through forty-seventh aspects, performing the multi-PTRS communication includes transmitting, from a plurality of TRPs of the base station, multiple PTRSs via a PDSCH.

In a forty-ninth aspect alternatively or in addition to one or more of the first through forty-eighth aspects, the multiple PTRSs include a first PTRS transmitted to a first antenna panel of the UE based on a first PTRS configuration of the multiple PTRS configurations and further include a second PTRS transmitted to a second antenna panel of the UE based on a second PTRS configuration of the multiple PTRS configurations.

In a fiftieth aspect alternatively or in addition to one or more of the first through forty-ninth aspects, performing the multi-PTRS communication includes receiving, from a plurality of antenna panels of the UE, multiple PTRSs via a PUSCH.

In a fifty-first aspect alternatively or in addition to one or more of the first through fiftieth aspects, the multiple PTRSs include a first PTRS received from a first antenna panel of the UE based on a first PTRS configuration of the multiple PTRS configurations and further include a second PTRS received from a second antenna panel of the UE based on a second PTRS configuration of the multiple PTRS configurations.

In a fifty-second aspect alternatively or in addition to one or more of the first through fifty-first aspects, the message is transmitted for each frequency band of a plurality of frequency bands.

In a fifty-third aspect alternatively or in addition to one or more of the first through fifty-second aspects, the message is transmitted for each serving cell of a plurality of serving cells.

In a fifty-fourth aspect alternatively or in addition to one or more of the first through fifty-third aspects, the method further includes transmitting, by the base station to the UE, one or more configuration messages indicating a selection of the one or more PTRS configurations.

In a fifty-fifth aspect alternatively or in addition to one or more of the first through fifty-fourth aspects, the one or more configuration messages are associated with a PUSCH.

In a fifty-sixth aspect alternatively or in addition to one or more of the first through fifty-fifth aspects, the one or more configuration messages are associated with a PDSCH.

In a fifty-seventh aspect alternatively or in addition to one or more of the first through fifty-sixth aspects, a first PTRS of the multi-PTRS communication is multiplexed with a second PTRS of the multi-PTRS communication based on a SDM scheme.

In a fifty-eighth aspect alternatively or in addition to one or more of the first through fifty-seventh aspects, a first PTRS of the multi-PTRS communication is multiplexed with a second PTRS of the multi-PTRS communication based on a FDM scheme.

In a fifty-ninth aspect alternatively or in addition to one or more of the first through fifty-eighth aspects, a first PTRS of the multi-PTRS communication is multiplexed with a second PTRS of the multi-PTRS communication based on a TDM scheme.

In a sixtieth aspect alternatively or in addition to one or more of the first through fifty-ninth aspects, a method of wireless communication includes receiving, by a base station from a UE, a request to associate a first PTRS configuration of multiple PTRS configurations with a first PTRS of a multi-PTRS communication and to associate a second PTRS configuration of the multiple PTRS configurations with a second PTRS of the multi-PTRS communication. The method further includes, after receiving the request, performing, by the base station, the multi-PTRS communication with the base UE.

In a sixty-first aspect alternatively or in addition to one or more of the first through sixtieth aspects, the request is included in an uplink MAC-CE that indicates one or more of a first TRP associated with the first PTRS, a second TRP associated with the second PTRS, a first panel ID associated with the first PTRS, or a second panel ID associated with the second PTRS.

In a sixty-second aspect alternatively or in addition to one or more of the first through sixty-first aspects, the request is included in uplink control information (UCI) that indicates one or more of a first TRP associated with the first PTRS, a second TRP associated with the second PTRS, a first panel ID associated with the first PTRS, or a second panel ID associated with the second PTRS.

In a sixty-third aspect alternatively or in addition to one or more of the first through sixty-second aspects, performing the multi-PTRS communication includes: receiving, from the UE, the first PTRS using a first TRP of the base station from a first antenna panel of the UE; and receiving, from the UE, the second PTRS using a second TRP of the base station from a second antenna panel of the UE.

In a sixty-fourth aspect alternatively or in addition to one or more of the first through sixty-third aspects, performing the multi-PTRS communication includes: transmitting, to the UE, the first PTRS using a first TRP of the base station to a first antenna panel of the UE; and transmitting, to the UE, the second PTRS using a second TRP of the base station to a second antenna panel of the UE.

In a sixty-fifth aspect alternatively or in addition to one or more of the first through sixty-fourth aspects, the request includes one or more of a minimum time domain density indicator associated with the UE or a minimum frequency domain density indicator associated with the UE.

In a sixty-sixth aspect alternatively or in addition to one or more of the first through sixty-fifth aspects, the request includes a first byte indicating an ID of a panel or a TRP, a time domain density indicator, a frequency domain density indicator, and a serving cell ID.

In a sixty-seventh aspect alternatively or in addition to one or more of the first through sixty-sixth aspects, the request further includes a second byte indicating a minimum frequency domain density indicated by the UE.

In a sixty-eighth aspect alternatively or in addition to one or more of the first through sixty-seventh aspects, the request further includes a third byte indicating a minimum time domain density indicated by the UE.

In a sixty-ninth aspect alternatively or in addition to one or more of the first through sixty-eighth aspects, a method of wireless communication includes receiving, by a base station from a UE, one or more configuration messages indicating multiple PTRS configurations. The method further includes performing, by the base station, a multi-PTRS communication with the UE based on one or more of the multiple PTRS configurations.

In a seventieth aspect alternatively or in addition to one or more of the first through sixty-ninth aspects, each PTRS configuration of the multiple PTRS configurations is associated with a respective TRP or panel ID.

In a seventy-first aspect alternatively or in addition to one or more of the first through seventieth aspects, the one or more configuration messages include a PTRS configuration message explicitly identifying each TRP or panel ID.

In a seventy-second aspect alternatively or in addition to one or more of the first through seventy-first aspects, the TRP or panel ID is determined using an implicit technique.

In a seventy-third aspect alternatively or in addition to one or more of the first through seventy-second aspects, the TRP or panel ID is determined based on one or more of a CORESET pool ID, a SRS resource ID, an SRS resource set ID, an uplink TCI ID, a CDM group ID, or another indicator associated with the TRP or panel ID.

In a seventy-fourth aspect alternatively or in addition to one or more of the first through seventy-third aspects, the method further includes transmitting, by the base station to the UE, scheduling information indicating a multi-panel PUSCH transmission of the multi-PTRS communication, wherein panel IDs are determined based on the scheduling information, and wherein the multi-panel PUSCH transmission is performed based on the panel IDs.

In a seventy-fifth aspect alternatively or in addition to one or more of the first through seventy-fourth aspects, the scheduling information includes a downlink control information (DCI) message that indicates multiple transmission configuration indicator (TCI) IDs, and the multiple PTRS configurations are applied to the multi-panel PUSCH transmission based on the DCI message indicating the multiple TCI IDs.

In a seventy-sixth aspect alternatively or in addition to one or more of the first through seventy-fifth aspects, the scheduling information includes a first downlink control information (DCI) message and a second DCI message, and the multiple PTRS configurations are applied to the multi-panel PUSCH transmission based on the first DCI message indicating a first CORESET pool index value and further based on the second DCI message indicating a second CORESET pool index value.

In a seventy-seventh aspect alternatively or in addition to one or more of the first through seventy-sixth aspects, a method of wireless communication includes receiving, by a base station from a UE, scheduling information, where UE is configured with multiple PTRS configurations. The method further includes, based on the scheduling information, performing a multi-PTRS communication by the base station with the UE. The multi-PTRS communication includes a first PTRS that is communicated based on a particular PTRS configuration of the multiple PTRS configurations and further includes a second PTRS that is communicated based on the particular PTRS configuration of the multiple PTRS configurations.

In a seventy-eighth aspect alternatively or in addition to one or more of the first through seventy-seventh aspects, performing the multi-PTRS communication includes receiving the first PTRS via a PUSCH based on the particular PTRS configuration from a first antenna panel of multiple antenna panels of the UE and further includes receiving the second PTRS via the PUSCH based on the particular PTRS configuration from a second antenna panel of the multiple antenna panels.

In a seventy-ninth aspect alternatively or in addition to one or more of the first through seventy-eighth aspects, the particular PTRS configuration is selected from among the multiple PTRS configurations based on an identification that the particular PTRS configuration is associated with a greatest time domain density among the multiple antenna panels.

In an eightieth aspect alternatively or in addition to one or more of the first through seventy-ninth aspects, the particular PTRS configuration is selected from among the multiple PTRS configurations based on an identification that the particular PTRS configuration is associated with a greatest frequency domain density among the multiple antenna panels.

In an eighty-first aspect alternatively or in addition to one or more of the first through eightieth aspects, the particular PTRS configuration is selected from among the multiple PTRS configurations based on an identification that the particular PTRS configuration is associated with a least time domain density among the multiple antenna panels.

In an eighty-second aspect alternatively or in addition to one or more of the first through eighty-first aspects, the particular PTRS configuration is selected from among the multiple PTRS configurations based on an identification that the particular PTRS configuration is associated with a least frequency domain density among the multiple antenna panels.

In an eighty-third aspect alternatively or in addition to one or more of the first through eighty-second aspects, performing the multi-PTRS communication includes transmitting the first PTRS via a PDSCH using a first TRP of multiple TRPs of the base station based on the particular PTRS configuration and further includes transmitting the second PTRS via the PDSCH using a second TRP of the multiple TRPs based on the particular PTRS configuration.

In an eighty-fourth aspect alternatively or in addition to one or more of the first through eighty-third aspects, the particular PTRS configuration is selected from among the multiple PTRS configurations based on an identification that the particular PTRS configuration is associated with a greatest time domain density among the multiple TRPs.

In an eighty-fifth aspect alternatively or in addition to one or more of the first through eighty-fourth aspects, the particular PTRS configuration is selected from among the multiple PTRS configurations based on an identification that the particular PTRS configuration is associated with a greatest frequency domain density among the multiple TRPs.

In an eighty-sixth aspect alternatively or in addition to one or more of the first through eighty-fifth aspects, the particular PTRS configuration is selected from among the multiple PTRS configurations based on an identification that the particular PTRS configuration is associated with a least time domain density among the multiple TRPs.

In an eighty-seventh aspect alternatively or in addition to one or more of the first through eighty-sixth aspects, the particular PTRS configuration is selected from among the multiple PTRS configurations based on an identification that the particular PTRS configuration is associated with a least frequency domain density among the multiple TRPs.

In an eighty-eighth aspect alternatively or in addition to one or more of the first through eighty-seventh aspects, the particular PTRS configuration is selected based on determining that the scheduling information indicates a panel or TRP that is not associated with any PTRS configuration.

In an eighty-ninth aspect alternatively or in addition to one or more of the first through eighty-eighth aspects, a non-transitory computer-readable medium stores instructions executable by a processor to perform operations. The operations include transmitting, by a UE to a base station, a message indicating support of multiple PTRS configurations. The operations further include, after transmitting the message, performing, by the UE with the base station, a multi-PTRS communication based on one or more PTRS configurations of the multiple PTRS configurations.

In a ninetieth aspect alternatively or in addition to one or more of the first through eighty-ninth aspects, an apparatus includes a memory and one or more processors coupled to the memory. The one or more processors are configured to transmit, by a UE to a base station, a message indicating support of multiple PTRS configurations. The one or more processors are further configured to perform, after transmitting the message, a multi-PTRS communication based on one or more PTRS configurations of the multiple PTRS configurations.

In a ninety-first aspect alternatively or in addition to one or more of the first through ninetieth aspects, an apparatus includes means for transmitting, by a UE to a base station, a message indicating support of multiple PTRS configurations. The apparatus further includes means for performing, by the UE with the base station after transmitting the message, a multi-PTRS communication based on one or more PTRS configurations of the multiple PTRS configurations.

In a ninety-second aspect alternatively or in addition to one or more of the first through ninety-first aspects, a non-transitory computer-readable medium stores instructions executable by a processor to perform operations. The operations include receiving, from a UE by a base station, a message indicating support of multiple PTRS configurations. The operations further include, after receiving the message, performing, by the base station with the UE, a multi-PTRS communication based on one or more PTRS configurations of the multiple PTRS configurations.

In a ninety-third aspect alternatively or in addition to one or more of the first through ninety-second aspects, an apparatus includes a memory and one or more processors coupled to the memory. The one or more processors are configured to receive, from a UE by a base station, a message indicating support of multiple PTRS configurations. The one or more processors are further configured to perform, after receiving the message, a multi-PTRS communication based on one or more PTRS configurations of the multiple PTRS configurations.

In a ninety-fourth aspect alternatively or in addition to one or more of the first through ninety-third aspects, an apparatus includes means for receiving, from a UE by a base station, a message indicating support of multiple PTRS configurations. The apparatus further includes means for performing, by the base station with the UE after receiving the message, a multi-PTRS communication based on one or more PTRS configurations of the multiple PTRS configurations.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and modules described herein (e.g., the components, functional blocks, and modules in FIG. 2) may comprise processors, electronics devices, hardware devices, electronics components, logical circuits, memories, software codes, firmware codes, etc., or any combination thereof. In addition, one or more features described herein may be implemented via specialized processor circuitry, via executable instructions, and/or combinations thereof.

Those of skill would further appreciate that the various illustrative logical blocks, modules, circuits, and operations (e.g., the operations illustrated in FIGS. 6 and 7) described in connection with the disclosure herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

One or more functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication, comprising:
transmitting, by a user equipment (UE) to a base station, a message indicating support of multiple phase tracking reference signal (PTRS) configurations; and
after transmitting the message, performing, by the UE with the base station, a multi-PTRS communication based on one or more PTRS configurations of the multiple PTRS configurations.

2. The method of claim 1, wherein the multiple PTRS configurations include a first time domain density associated with a first PTRS of the multi-PTRS communication and further include a second time domain density associated with a second PTRS of the multi-PTRS communication, the second time domain density different than the first time domain density.

3. The method of claim 1, wherein the multiple PTRS configurations include a first frequency domain density associated with a first PTRS of the multi-PTRS communication and further include a second frequency domain density associated with a second PTRS of the multi-PTRS communication, the second frequency domain density different than the first frequency domain density.

4. The method of claim 1, wherein performing the multi-PTRS communication includes receiving, from a plurality of transmission and reception points (TRPs) of the base station, multiple PTRSs, and wherein the multiple PTRSs include a first PTRS transmitted to a first antenna panel of the UE based on a first PTRS configuration of the multiple PTRS configurations and further include a second PTRS transmitted to a second antenna panel of the UE based on a second PTRS configuration of the multiple PTRS configurations.

5. The method of claim 1, wherein performing the multi-PTRS communication includes transmitting, using a plurality of antenna panels of the UE, multiple PTRSs to the base station via a physical uplink shared channel (PUSCH), and wherein the multiple PTRSs include a first PTRS transmitted by a first antenna panel of the UE based on a first PTRS configuration of the multiple PTRS configurations and further include a second PTRS transmitted by a second antenna panel of the UE based on a second PTRS configuration of the multiple PTRS configurations.

6. The method of claim 1, wherein the UE transmits the message for each frequency band of a plurality of frequency bands or for each serving cell of a plurality of serving cells.

7. The method of claim 1, further comprising:
receiving, by the UE from the base station, one or more configuration messages indicating a selection of the one or more PTRS configurations, wherein the one or more configuration messages are associated with a physical uplink shared channel (PUSCH).

8. The method of claim 1, wherein a first PTRS of the multi-PTRS communication is multiplexed with a second PTRS of the multi-PTRS communication based on a spatial division multiplexing (SDM) scheme, based on a frequency division multiplexing (FDM) scheme, or based on a time division multiplexing (TDM) scheme.

9. A method of wireless communication, comprising:
transmitting, by a user equipment (UE) to a base station, a request to associate a first phase tracking reference signal (PTRS) configuration of multiple PTRS configurations with a first PTRS of a multi-PTRS communication and to associate a second PTRS configuration of the multiple PTRS configurations with a second PTRS of the multi-PTRS communication; and
after transmitting the request, performing, by the UE, the multi-PTRS communication with the base station.

10. The method of claim 9, wherein the request is included in an uplink medium access control (MAC) control element (MAC-CE) that indicates one or more of a first transmission and reception point (TRP) associated with the first PTRS, a second TRP associated with the second PTRS, a first panel identifier (ID) associated with the first PTRS, or a second panel ID associated with the second PTRS.

11. The method of claim 9, wherein the request is included in uplink control information (UCI) that indicates one or more of a first transmission and reception point (TRP) associated with the first PTRS, a second TRP associated with the second PTRS, a first panel identifier (ID) associated with the first PTRS, or a second panel ID associated with the second PTRS.

12. The method of claim 9, wherein performing the multi-PTRS communication includes:
receiving, by the UE, the first PTRS from a first transmission and reception point (TRP) of the base station using a first antenna panel of the UE; and
receiving, by the UE, the second PTRS from a second TRP of the base station using a second antenna panel of the UE.

13. The method of claim 9, wherein performing the multi-PTRS communication includes:
transmitting, by the UE, the first PTRS to a first transmission and reception point (TRP) of the base station using a first antenna panel of the UE; and
transmitting, by the UE, the second PTRS to a second TRP of the base station using a second antenna panel of the UE.

14. The method of claim 9, wherein the request includes one or more of a minimum time domain density indicator associated with the UE or a minimum frequency domain density indicator associated with the UE.

15. The method of claim 9, wherein the request includes:
a first byte indicating an identifier (ID) of a panel or a transmission and reception point (TRP), a time domain density indicator, a frequency domain density indicator, and a serving cell ID;
a second byte indicating a minimum frequency domain density indicated by the UE; and
a third byte indicating a minimum time domain density indicated by the UE.

16. A method of wireless communication, comprising:
receiving, by a user equipment (UE) from a base station, one or more configuration messages indicating multiple phase tracking reference signal (PTRS) configurations; and
performing, by the UE, a multi-PTRS communication with the base station based on one or more of the multiple PTRS configurations.

17. The method of claim 16, wherein each PTRS configuration of the multiple PTRS configurations is associated with a respective transmission and reception point (TRP) or panel identifier (ID).

18. The method of claim 17, wherein the one or more configuration messages include a PTRS configuration message explicitly identifying each TRP or panel ID.

19. The method of claim 17, further comprising determining the TRP or panel ID using an implicit technique, wherein the TRP or panel ID is determined based on one or more of a control resource set (CORESET) pool ID, a sounding reference signal (SRS) resource ID, an SRS resource set ID, an uplink transmission configuration indicator (TCI) ID, a code division multiplexing (CDM) group ID, or another indicator associated with the TRP or panel ID.

20. The method of claim 16, further comprising:
receiving, by the UE, scheduling information from the base station indicating a multi-panel physical uplink shared channel (PUSCH) transmission of the multi-PTRS communication;
determining panel identifiers (IDs) based on the scheduling information; and
performing the multi-panel PUSCH transmission based on the panel IDs.

21. The method of claim 20, wherein the scheduling information includes a downlink control information (DCI) message that indicates multiple transmission configuration indicator (TCI) IDs, and wherein the UE applies the multiple PTRS configurations to the multi peel PUSCH transmission based on the DCI message indicating the multiple TCI IDs.

22. The method of claim 20, wherein the scheduling information includes a first downlink control information (DCI) message and a second DCI message, and wherein the UE applies the multiple PTRS configurations to the multi-panel PUSCH transmission based on the first DCI message indicating a first control resource set (CORESET) pool index value and further based on the second DCI message indicating a second CORESET pool index value.

23. A method of wireless communication, comprising:
receiving, by a user equipment (UE), scheduling information from a base station, wherein the UE is configured with multiple phase tracking reference signal (PTRS) configurations; and
based on the scheduling information, performing a multi-PTRS communication by the UE, wherein the multi-PTRS communication includes a first PTRS that is communicated based on a particular PTRS configuration of the multiple PTRS configurations and further includes a second PTRS that is communicated based on the particular PTRS configuration of the multiple PTRS configurations.

24. The method of claim 23, wherein performing the multi-PTRS communication includes transmitting the first PTRS via a physical uplink shared channel (PUSCH) based on the particular PTRS configuration using a first antenna panel of multiple antenna panels of the UE and further includes transmitting the second PTRS via the PUSCH based on the particular PTRS configuration using a second antenna panel of the multiple antenna panels.

25. The method of claim 24, further comprising selecting the particular PTRS configuration from among the multiple PTRS configurations based on an identification that the particular PTRS configuration is associated with a greatest time domain density among the multiple antenna panels.

26. The method of claim 24, further comprising selecting the particular PTRS configuration from among the multiple PTRS configurations based on an identification that the particular PTRS configuration is associated with a greatest frequency domain density among the multiple antenna panels.

27. The method of claim 24, further comprising selecting the particular PTRS configuration from among the multiple PTRS configurations based on an identification that the particular PTRS configuration is associated with a least time domain density among the multiple antenna panels.

28. The method of claim 24, further comprising selecting the particular PTRS configuration from among the multiple PTRS configurations based on an identification that the particular PTRS configuration is associated with a least frequency domain density among the multiple antenna panels.

29. The method of claim 23, wherein performing the multi-PTRS communication includes receiving the first PTRS from a first transmission and reception point (TRP) of multiple TRPs of the base station based on the particular PTRS configuration and further includes receiving the second PTRS from a second TRP of the multiple TRPs based on the particular PTRS configuration.

30. The method of claim 29, further comprising selecting the particular PTRS configuration from among the multiple PTRS configurations based on an identification that the particular PTRS configuration is associated with a greatest time domain density among the multiple TRPs, a greatest frequency domain density among the multiple TRPs, a least time domain density among the multiple TRPs, a least frequency domain density among the multiple TRPs, or based on determining that the scheduling information indicates a panel or TRP that is not associated with any PTRS configuration.
